(19) United States
(12) Patent Application Publication
(10) Pub. No.: US 2021/0317854 A1
(43) Pub. Date: Oct. 14, 2021

(54) COMPONENT ATTACHING STRUCTURE

(71) Applicant: AISIN SEIKI KABUSHIKI KAISHA, Kariya-shi (JP)

(72) Inventor: KEN KATO, Kariya-shi (JP)

(73) Assignee: AISIN SEIKI KABUSHIKI KAISHA, Kariya-shi (JP)

(21) Appl. No.: 17/208,617

(22) Filed: Mar. 22, 2021

(30) Foreign Application Priority Data
Apr. 8, 2020 (JP) 2020-069606

(51) Int. Cl. F16B 5/04

(52) U.S. Cl. CPC F16B 5/04

(57) ABSTRACT

Provided is a low-cost component attaching structure having a simple structure and enabling easy operation. The component attaching structure includes a female screw part formed on one of a fixed part provided on a vehicle side and a component attached to the fixed part, an opening for attachment provided on the other of the fixed part and the component, and a blind rivet engaged with the female screw part through the opening.

### CROSS REFERENCE TO RELATED APPLICATIONS

This application is based on and claims priority under 35 U.S.C. § 119 to Japanese Patent Application 2020-069606, filed on Apr. 8, 2020, the entire content of which is incorporated herein by reference.

### TECHNICAL FIELD

This disclosure generally relates to an attaching structure for a fixed part provided on a vehicle side and a component attached to the fixed part.

### BACKGROUND DISCUSSION

Examples of a known conventional component attaching structure include JP2006-7956A (Reference 1). In a steering device for a vehicle according to Reference 1, a steering column rotatably housing and supporting a steering wheel and a steering shaft is tiltably fixed with respect to a U-shaped bracket provided on the vehicle side. Pressure members pressing the steering column are provided between left and right brackets and the steering column.

Examples of the pressure member include a U-shaped leaf spring attached to a wall part of a bracket with a bolt with an end of the leaf spring being urged to a housing and being brought in contact with the housing (FIG. 3), and a sliding member pressed against the housing with a coil spring placed in a hole on a wall of a bracket with the bracket as a reaction force receiver (FIG. 5).

The housing is urged and fixed to a neutral position between the left and right brackets by the pressure members. As a result, rigidity of the steering device against the bracket is enhanced, and vibration transferred to the steering wheel is suppressed.

However, when the housing is incorporated between the brackets in the aforementioned conventional component attaching structure, an operation of inserting the housing while compressing a spring is required. The spring is urged inwardly from the bracket. Accordingly, when the housing is inserted between the brackets, the spring needs to be kept at a predetermined position under a condition of a workspace being narrowed by the inserted housing.

Such an operation is extremely complicated, and when a spring constant is large, a level of difficulty of the operation of deforming and keeping the spring particularly increases. Since predetermined man-hours for attachment are also required, there is a limit to reduction of manufacturing costs.

A need thus exists for a component attaching structure which is not susceptible to the drawback mentioned above.

### SUMMARY

A component attaching structure according to this disclosure includes a female screw part, an opening for attachment, and a blind rivet. The female screw part is formed on one of a fixed part provided on a vehicle side and a component attached to the fixed part. The opening is provided on the other of the fixed part and the component. The blind rivet is engaged with the female screw part through the opening.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram illustrating a component attaching structure according to a first embodiment;

FIG. 2 is a cross-sectional view illustrating the component attaching structure according to the first embodiment;

FIG. 3A and FIG. 3B are diagrams illustrating the component attaching structure according to the first embodiment;

FIG. 4A and FIG. 4B are diagrams illustrating a component attaching structure according to a second embodiment;

FIG. 5 is a cross-sectional view illustrating a structure of a sliding part according to the second embodiment;

FIG. 6A and FIG. 6B are perspective views illustrating the structure of the sliding part according to the second embodiment;

FIG. 7A and FIG. 7B are cross-sectional views illustrating the structure of the sliding part according to the second embodiment before and after assembly; and

FIG. 8 is a cross-sectional view illustrating a structure of a sliding part according to another embodiment.

### DETAILED DESCRIPTION

### First Embodiment

Outline

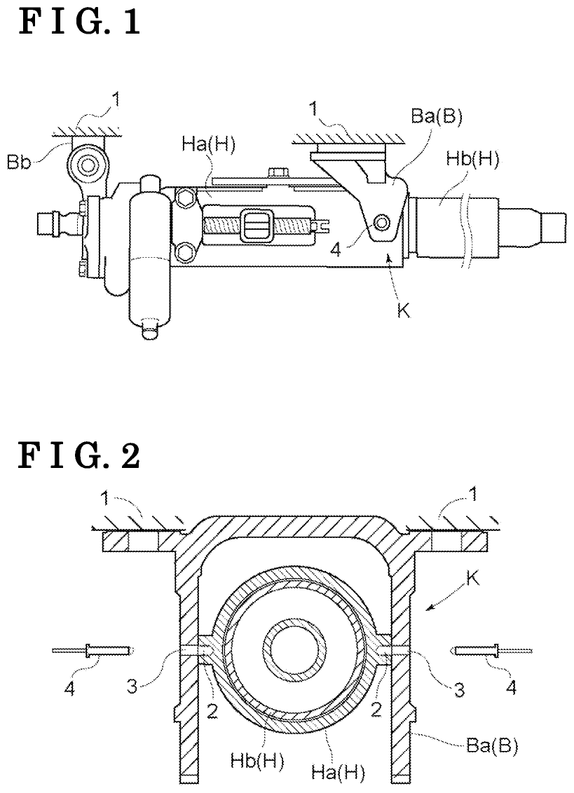

For example, a component attaching structure K according to this disclosure is a structure in which various components H are attached to a fixed part B provided on a vehicle 1 side. As a basic structure, a female screw part 2 is formed on either one of the fixed part B and the component H, and an opening 3 facing the female screw part 2 is formed on the other. A blind rivet 4 externally inserted into the female screw part 2 through the opening 3 is used for fixing the component H to the fixed part B. A first embodiment according to this disclosure will be explained with reference to FIG. 1 to FIG. 3.

An example of attaching a column housing Ha (hereinafter referred to as a housing Ha) being a component H to a bracket Ba being a fixed part B is described in the first embodiment. As illustrated in FIG. 1 and FIG. 2, the housing Ha pivotably supports a steering shaft Hb to which a steering wheel is attached in a steering device in a vehicle 1. As illustrated in FIG. 1 and FIG. 2, the housing Ha is supported by the vehicle 1 with the bracket Ba at the rear and a bracket Bb at the front. The bracket Ba at the rear in particular is a U-shaped member.

As illustrated in FIG. 2, female screw parts 2 are formed on the housing Ha. Circular through-holes are formed on the bracket Ba at the rear as openings 3. A blind rivet 4 is inserted into the female screw part 2 and the opening 3 for fixing.

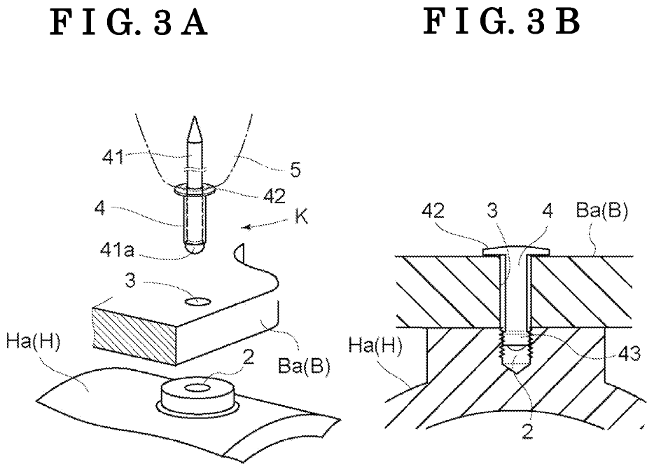

FIGS. 3A and 3B illustrate states of the blind rivet 4 before fitting and after fitting. As illustrated in FIG. 3A, the blind rivet 4 is inserted into the female screw part 2 through the opening 3, and a core material 41 is extracted by use of a riveter 5. At this time, the tip of the riveter 5 presses a head 42 of the blind rivet 4 to the bracket Ba side. A swelling part 41a formed at an end of the core material 41 acts on an end of the blind rivet 4, forms an enlarged-diameter part 43, and engages the enlarged-diameter part 43 with the female screw part 2. The riveter 5 draws the core material 41 while pressing the head 42; however the enlarged-diameter part 43 is engaged with the female screw part 2 and prevents further movement. Consequently, tensile stress of the core material 41 increases, and the core material 41 breaks. The blind rivet 4 urges the bracket Ba and the housing Ha in such a direction as to bring the two in proximity to each other at the head 42 at one end and the enlarged-diameter part 43 at the other end and fixes the two.

Thus, by engaging the blind rivet 4 with the female screw part 2, engagement of the enlarged-diameter part 43 is further secured. Further, for example, when the female screw part 2 is formed, tapping may be performed after making a prepared hole with an ordinary drill, and thus forming of the female screw part 2 is easy. Accordingly, the component attaching structure K can be reasonably formed.

Fastening of the blind rivet 4 can be performed from the opening side of the female screw part 2 and therefore is extremely simple. Further, by forming the female screw part 2, a locking effect with the outer surface of the enlarged-diameter part 43 of the blind rivet 4 is enhanced. Accordingly, a highly durable fixed part B resistant to looseness in rivet fixing even when being put to long-term use can be acquired.

Furthermore, the cost of the blind rivet 4 is lower than that of a bolt or a screw, and formation of the female screw part 2 is easy when an ordinary tap or the like is used; and therefore a component attaching structure K with a low overall cost can be acquired.

An ordinary rivet may be used in place of the blind rivet 4. The diameter of an end of an ordinary rivet on the tip side along an insertion direction is enlarged by striking a head on the opposite side with a hammer or the like while receiving the end on the tip side. Accordingly, it is preferable to set the depth of the female screw part 2 according to the rivet size in such a way that, when the head of the rivet is struck by a hammer, the end of the rivet on the tip side just comes in contact with the bottom of the female screw part 2, is crushed, and bites into the female screw part 2 while the diameter thereof being enlarged.

### Second Embodiment

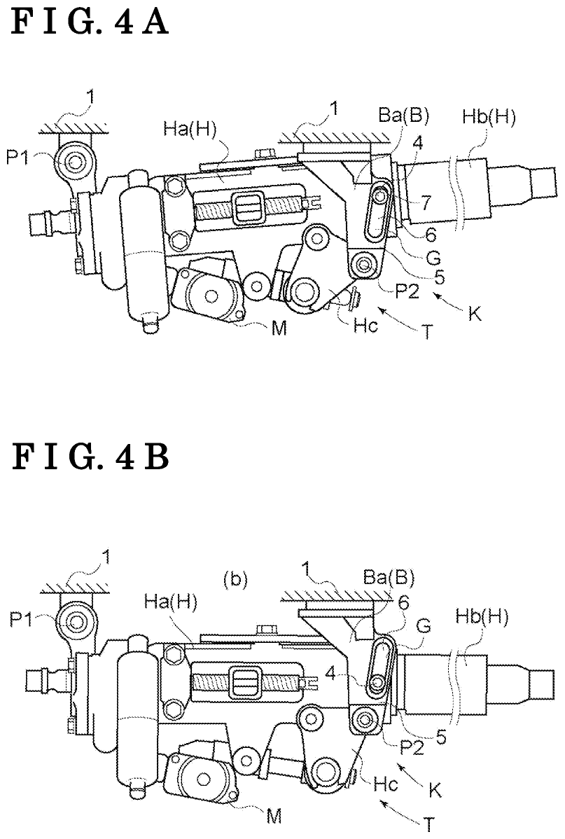

FIG. 4 to FIG. 7 illustrate an example of slidably attaching a column housing Ha (hereinafter referred to as a housing Ha) pivotably supporting a steering shaft Hb to a bracket Ba on a vehicle 1 side in a steering device including a tilt structure T of a steering wheel.

FIGS. 4A and 4B illustrate states of a housing Ha being set at an upper position and a lower position, respectively. A sliding part G constituting the tilt structure T is provided on the housing Ha. The housing Ha is supported by a vehicle 1 with a first fulcrum P1 at the front and a second fulcrum P2 provided on the bracket Ba at the rear. A crank part Hc of the housing Ha on which the second fulcrum P2 is provided is rotated by a tilt driving motor M. Consequently, the housing Ha tilts with respect to the bracket Ba.

Sliding Part

The sliding part G is formed between the bracket Ba and the housing Ha. As illustrated in FIG. 4 to FIG. 6, a slide groove 6 is formed on the bracket Ba. An edge 61 of the slide groove 6 is pressed to the housing Ha side by use of a blind rivet 4 in this embodiment. However, since the blind rivet 4 moves along the slide groove 6, a top member 7 is placed on the slide groove 6 for the purpose of smoothing the tilting of the housing Ha or the like, and the blind rivet 4 is fitted through the top member 7.

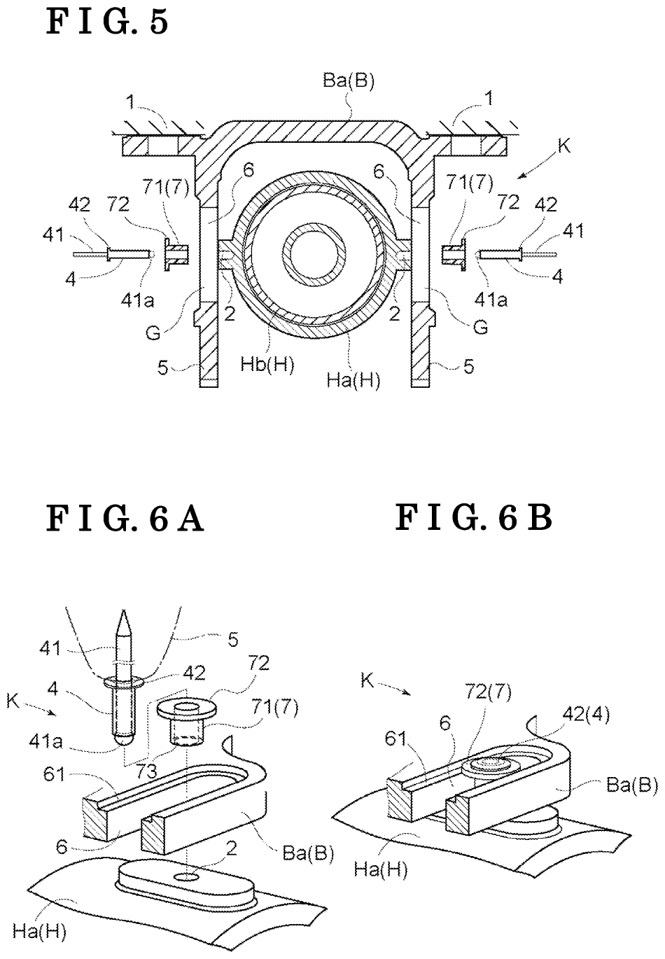

As illustrated in FIG. 5 and FIG. 6, the top member 7 includes a tubular base 71 placed inside the slide groove 6 in such a way as to be able to follow the housing Ha. The blind rivet 4 is inserted into the base 71, and the base 71 is pressed to the housing Ha side by the blind rivet 4 being engaged with a female screw part 2. A flange part 72 in contact with the edge 61 of the slide groove 6 is formed at one end of the base 71.

By the flange part 72 being in contact with the edge 61, the housing Ha can be fixed to the bracket Ba without a backlash. However, it is preferable when the housing Ha performs tilting that the flange part 72 exert an elastic force and elastically urge the edge 61 toward the housing Ha, as described below.

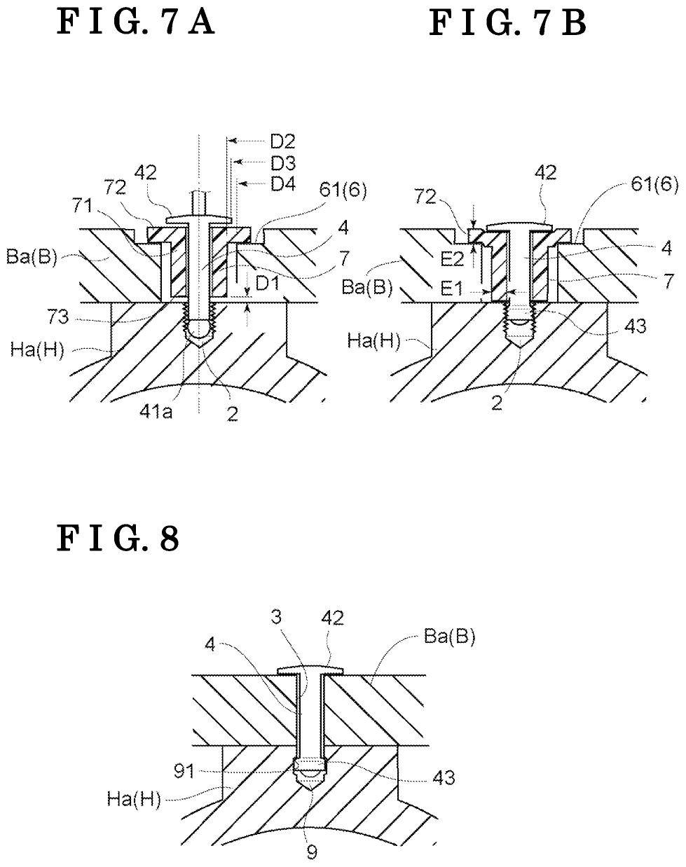

FIGS. 7A and 7B illustrate states of the blind rivet 4 before and after fixing, respectively. A head 42 of the blind rivet 4 urges the central part of the top member 7. Consequently, the edge of the flange part 72 of the top member 7 comes in contact with the slide groove 6. At this time, a gap D1 is formed between a contact surface 73 at the bottom of the base 71 and the surface of the housing Ha. The head 42 presses the base 71 in such a way as to eliminate the gap D1, and a preset amount of bending is generated in the flange part 72, as illustrated in FIG. 7B.

In this case, it is preferable that an outer diameter D3 of the head 42 of the blind rivet 4 be formed smaller than a width D4 of the slide groove 6.

Consequently, a part of the back side of the flange part 72, the part being in contact with the slide groove 6, and a part of the front side of the flange part 72, the part being in contact with the head 42 are positioned differently in a direction viewed along the urging direction. Accordingly, the flange part 72 can be securely bent, and a predetermined urging force can be generated.

Further, it is preferable that the outer diameter D3 of the head 42 be formed larger than an outer diameter D2 of the base 71.

In this structure, when the edge of the head 42 presses the top member 7, a part of the flange part 72 positioned outside the base 71 is pressed. Accordingly, excessive bending deformation is not likely to be generated at the boundary position between the base 71 and the flange part 72. Since the relative angle between the surface of the base 71 and the surface of the flange part 72 is a right angle, for example, when a pressing force exerted by the blind rivet 4 solely acts on the base 71, the flange part 72 may be damaged due to concentration of stress on the aforementioned boundary position. However, in this structure, the outer edge of an acting position of the pressing force exerted by the blind rivet 4 is a midway position on the flange part 72; and thus stress concentration is relaxed, and the flange part 72 can be suitably deformed.

Movement of the top member 7 pressed by the head 42 is restricted to a position where the contact surface 73 comes in contact with the housing Ha. By thus regulating movement of the base 71 and keeping an amount of deformation of the flange part 72 constant, an urging force generated by the flange part 72 can be kept constant. Consequently, smooth sliding movement of the housing Ha can be achieved while suppressing a backlash of the housing Ha against the bracket Ba. Further, as a result of regulating excessive deformation of the flange part 72, damage to the flange part 72 is also prevented.

An ordinary rivet, a bolt, or the like besides the blind rivet 4 may also be used. In other words, any member that can cause a pressing force to act on the top member 7 with the female screw part 2 provided on the housing Ha side as a reaction force receiver and can clamp the bracket Ba can be used.

It is preferable to form the top member 7 with, for example, resin in order to enhance slidability with the slide groove 6. In that case, while, for example, the top member 7 can be manufactured by injection molding of resin, or the like, it is preferable to keep the length of the base 71, the thickness of the flange part 72, and the like as constant as possible in order to keep the pressing force on the flange part 72 constant. In injection molding of resin, a cooling condition after the injection molding is important; and when the cooling condition differs from part to part, the solidification rate of the resin changes, and an error occurs in the dimensions of the member. Then, when the top member 7 in this structure is molded with resin, dimensional accuracy is secured by equally forming a thickness E1 of the base 71 and a thickness E2 of the flange part 72, as illustrated in FIG. 7B.

As described above, a component attaching structure K using the top member 7 and the blind rivet 4 has a simple structure and allows easy assembly; and thus a steering device with a compact overall size can be acquired.

Further, by appropriately setting the dimensions of the top member 7 and the blind rivet 4, and the urging force generated by the flange part 72 of the top member 7, the housing Ha can be brought in contact with the bracket Ba when fixing of the top member 7 is completed. In this case, the bracket Ba and the housing Ha are almost integrated, and thus holding rigidity of the housing Ha becomes extremely high. Accordingly, a steering device with an excellent steering feel can be acquired.

### Third Embodiment

A hole 9 including a large-diameter part 91 with a widened inner diameter on the deeper side may be formed on a housing Ha in place of the female screw part 2, as illustrated in FIG. 8. The large-diameter part 91 can be formed by, for example, cutting the inner peripheral surface after forming the ordinary hole 9. The number of contact points is less with such a large-diameter part 91 when an enlarged-diameter part 43 is formed at the end of a blind rivet 4 compared with the case of the aforementioned female screw part 2; and therefore diameter-enlarging deformation can be performed easily. Accordingly, an operating force of a riveter 5 at fitting is reduced, and operating efficiency is improved.

### INDUSTRIAL APPLICABILITY

For example, the component attaching structure according to this disclosure can be widely used in a part where various components are attached to a fixed part provided on a vehicle.

A component attaching structure according to this disclosure includes a female screw part, an opening for attachment, and a blind rivet. The female screw part is formed on one of a fixed part provided on a vehicle side and a component attached to the fixed part. The opening is provided on the other of the fixed part and the component. The blind rivet is engaged with the female screw part through the opening.

In fixing of a component with a blind rivet, the blind rivet is inserted into a riveter being a fastening tool, the tip of the rivet is inserted into a hole for fixing, and then a core material of the blind rivet is extracted by operating a handle of the riveter. Consequently, an enlarged-diameter part formed at an end of the core material acts on an end of the blind rivet, and an enlarged-diameter part is formed. Displacement of the core material in the extraction direction is regulated with formation of the enlarged-diameter part, and tensile stress acting on the core material increases. A notch is formed on a part of the core material, and the core material on the riveter side breaks from the notch; and then fastening is completed.

When a blind rivet is used as is the case with this structure, the blind rivet can be inserted from the outside of the female screw part, and therefore fastening is extremely simple.

Further, by forming the female screw part as a hole for fixing, a locking effect with the outer surface of the enlarged-diameter part formed at the end of the blind rivet increases. Accordingly, a highly durable fixed part resistant to looseness in rivet fixing even when being put to long-term use can be acquired.

Furthermore, the cost of the blind rivet is lower than that of a bolt or a screw, and formation of the female screw part is easy by using an ordinary tap or the like, and therefore a component attaching structure with a low overall cost can be acquired.

In the component attaching structure according to this disclosure, the component may be a column housing containing a steering shaft related to steering of the vehicle, the female screw part being formed on the column housing and the fixed part may be a bracket including a slide groove as the opening in such a way as to enable tilting of the column housing; and the component attaching structure may further include a top member including a cylindrical base placed inside the slide groove and a flange part being formed at an end opposite to the column housing out of two ends of the base and being able to come in contact with an edge of the slide groove, the blind rivet being inserted into the top member.

By using a blind rivet when the tiltable column housing is attached to the bracket on the vehicle side as is the case with this structure, fixing becomes extremely simple compared with the aforementioned conventional technology. Accordingly, the manufacturing cost of the vehicle is reduced.

Further, by placing, in the slide groove of the bracket, the top member including the flange part being able to come in contact with the edge of the slide groove, slidability of the column housing with the bracket can be enhanced. The flange part can also clear a backlash of the column housing against the bracket as long as the flange part comes in contact with the bracket by a fastening force of the blind rivet.

In the component attaching structure according to this disclosure, a contact surface may be formed at an end of the base opposite to the flange part, the contact surface coming in contact with the column housing in a state of the top member being pressed to the column housing side by a head of the blind rivet and bending being generated in the flange part.

When the top member comes in contact with the column housing in a state of bending being generated in the flange part as is the case with this structure, a fixing force of the column housing exerted on the bracket becomes elastic. The top member moves relatively to the bracket at tilting of the column housing. Accordingly, the relative position between the flange part of the top member and the edge of the bracket changes when the top member moves.

Assuming that the flange part of the top member does not undergo deformation at all, a gap between the flange part and the edge changes when the top member moves, and slide resistance of the column housing to movement by tilting changes. In particular, at a position where slide resistance decreases, a gap may be generated between the top member and the bracket, and thus a backlash may be caused between the two.

In this respect, moderate bending is generated in the flange part by the contact surface at the end of the top member coming in contact with the column housing in this structure. Consequently, a predetermined urging force is generated between the column housing and the bracket while preventing excessive deformation of the flange part. Accordingly, the column housing can perform smooth tilting without a backlash, and damage to the flange part is prevented as well; and therefore a highly durable component attaching structure can be acquired.

In the component attaching structure according to this disclosure, an outer diameter of a head of the blind rivet may be formed smaller than a width of the slide groove.

By forming the outer diameter of the head of the blind rivet smaller than the width of the slide groove, a position where the outer edge of the head presses the flange part becomes different from a position where the flange part receives a reaction force from the edge of the slide groove, along a pressing direction of the head. In this case, bending in the flange part is more likely to be formed, and a bending force caused by the aforementioned bending is generated in addition to an elastic force based on compressive deformation of the flange part itself along the aforementioned pressing direction. Accordingly, elastic fixing of the column housing to the bracket becomes more secure.

In the component attaching structure according to this disclosure, the outer diameter may be formed larger than an outer diameter of the base.

In this structure, when the edge of the head of the rivet presses the top member, a part positioned outside the base on the flange part is pressed. Consequently, excessive bending deformation is not likely to be caused at a boundary position between the base and the flange part, and therefore damage at the base of the flange part can be prevented.

In the component attaching structure according to this disclosure, the top member may be formed of a resin material, and a thickness of the base and a thickness of the flange part may be equally formed.

By forming the top member with a resin material, slidability between the top member and the slide groove increases. Accordingly, tilting of the column housing becomes smooth.

Further, when forming the top member with a resin material, dimensional accuracy of a member may be impaired depending on cooling conditions at injection molding or the like. However, by equalizing the thickness of the base and the thickness of the flange part, the cooling conditions become identical, and excellent dimensional accuracy can be maintained.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A component attaching structure comprising:
a female screw part formed on one of a fixed part provided on a vehicle side and a component attached to the fixed part;
an opening for attachment provided on another of the fixed part and the component; and
a blind rivet engaged with the female screw part through the opening.

2. The component attaching structure according to claim 1, wherein
the component is a column housing containing a steering shaft related to steering of the vehicle, the female screw part being formed on the column housing,
the fixed part is a bracket including a slide groove as the opening in such a way as to enable tilting of the column housing, and the component attaching structure further comprising
a top member including a cylindrical base placed inside the slide groove and a flange part being formed at an end opposite to the column housing out of two ends of the base and being able to come in contact with an edge of the slide groove, the blind rivet being inserted into the top member.

3. The component attaching structure according to claim 2, wherein
a contact surface is formed at an end of the base opposite to the flange part, the contact surface coming in contact with the column housing in a state of the top member being pressed to the column housing side by a head of the blind rivet and bending being generated in the flange part.

4. The component attaching structure according to claim 2, wherein
an outer diameter of a head of the blind rivet is formed smaller than a width of the slide groove.

5. The component attaching structure according to claim 4, wherein
the outer diameter is formed larger than an outer diameter of the base.

6. The component attaching structure according to claim 2, wherein
the top member is formed of a resin material, and a thickness of the base and a thickness of the flange part are equally formed.
